(19) United States
(12) Patent Application Publication
(10) Pub. No.: US 2026/0310290 A1
(43) Pub. Date: Oct. 8, 2026

(54) EMOTIVE ASSISTANT WITH ATTENTION-BASED INTERACTION CAPABILITIES

(71) Applicant: OpenAI OpCo, LLC, San Francisco, CA (US)

(72) Inventor: Eric Gonzalez, San Francisco, CA (US)

(21) Appl. No.: 19/637,988

(22) Filed: Apr. 2, 2026

Related U.S. Application Data
(60) Provisional application No. 63/783,098, filed on Apr. 3, 2025.

(51) Int. Cl. G06F 3/01; G06F 3/16; G06T 7/70

(52) U.S. Cl. CPC G06F 3/013; G06F 3/167; G06T 7/70; G06T 2207/30201

(57) ABSTRACT

An electronic device may be configured to capture a user’s attention with motion outputs. The electronic device may include a body structure, an actuation system configured to produce device motion, an image capture system, and a processing system operatively coupled to the image capture system and the actuation system. The processing system may be configured to detect an event associated with information to be conveyed to a user, in response to detecting the event, cause the actuation system to produce a selected device motion configured to capture the user’s attention, capture an image of the user with the image capture system, analyze the image of the user to determine an attention state of the user, and in accordance with a determination that the attention state of the user is indicative of attention being directed to the electronic device, cause the actuation system to cease producing the selected device motion.

### CROSS-REFERENCE TO RELATED APPLICATION

This application is a nonprovisional patent application of and claims the benefit under 35 U.S.C. § 119(e) of U.S. Provisional Patent Application No. 63/783,098, filed April 3, 2025, and titled “Emotive Assistant with Attention-Based Interaction Capabilities,” the contents of which are incorporated herein by reference in its entirety.

### FIELD

The described embodiments relate generally to electronic companions. More particularly, the present embodiments relate to an electronic companion configured to produce attention cues with device motion and respond to physical attention cues from a user.

### BACKGROUND

Electronic devices can be configured to operate as electronic companions, performing a variety of tasks in response to a user command. For example, electronic companions may detect user inputs, such as voice commands, and may perform actions that are specified by the voice commands. Electronic companions may also provide outputs, such as confirmations of tasks or conveying the results of a task, through audible or visual outputs.

### SUMMARY

An electronic device may be configured to capture a user’s attention with motion outputs. The electronic device may include a body structure, an actuation system configured to produce device motion, an image capture system, and a processing system operatively coupled to the image capture system and the actuation system. The processing system may be configured to detect an event associated with information to be conveyed to a user, in response to detecting the event, cause the actuation system to produce a selected device motion configured to capture the user’s attention, capture an image of the user with the image capture system, analyze the image of the user to determine an attention state of the user, and in accordance with a determination that the attention state of the user is indicative of attention being directed to the electronic device, cause the actuation system to cease producing the selected device motion.

The electronic device may further include an articulatable member, the actuation system may be configured to move the articulatable member, and causing the actuation system to produce the selected device motion includes causing the actuation system to move the articulatable member. The actuation system may include a propulsion system, and causing the actuation system to produce the selected device motion may include causing the propulsion system to move the electronic device within its surroundings.

The processing system may be further configured to, prior to causing the actuation system to produce the selected device motion, select the device motion from a set of candidate device motions.

Analyzing the image of the user to determine the attention state of the user may include providing the image of the user as input to an attention identification model, the attention identification model trained on a set of images annotated with respective attention state information of respective subjects, and receiving, as output from the attention identification model, an indication of the attention state of the user.

The processing system may be further configured to, in accordance with a determination that the attention state of the user is not indicative of attention being directed to the electronic device, cause the actuation system to produce an alternative device motion.

Analyzing the image of the user to determine the attention state of the user may include determining whether a gaze of the user is aimed at the electronic device.

An electronic device may be configured to indicate a device state to a user via motion outputs. The electronic device may include a body structure, an actuation system configured to produce device motion, an input system including an image capture system and an audio input system, and a processing system operatively coupled to the input system and the actuation system. The processing system may be configured to detect, from a user and with the input system, a request to initiate an interaction with the electronic device, and in response to detecting the request, select a device motion configured to indicate that the electronic device has received the request and that the electronic device has entered an interactive mode, and cause the actuation system to produce the selected device motion.

The electronic device may further include a display configured to produce graphical outputs, and determining the device motion may include determining a location of the user relative to the electronic device and determining a motion that will cause the display to be oriented towards the user.

The electronic device may further include a movable structure representative of a facial feature, and determining the device motion may include determining a motion of the movable structure that is indicative of attention being directed to the user. The movable structure may be representative of an eye.

Detecting the request to initiate the interaction with the electronic device may include detecting, with the audio input system, an audio output from the user. Detecting the request to initiate the interaction with the electronic device may include detecting, with the image capture system, a motion of the user indicative of the user’s attention being directed to the electronic device. Detecting the request to initiate the interaction with the electronic device may include determining, with the image capture system, that a gaze of the user is aimed at the electronic device.

An electronic device may be configured to initiate an interactive mode in response to an attention cue from a user. The electronic device may include a body structure, an actuation system configured to produce device motion, an image capture system configured to capture an image of a user, and a processing system operatively coupled to the image capture system and the actuation system. The processing system may be configured to detect, based on an analysis of the image of the user, an occurrence of an attention cue by the user, in response to detecting the occurrence of the attention cue, select a device motion configured to indicate that the electronic device has detected the attention cue and that the electronic device has entered an interactive mode, and cause the actuation system to produce the selected device motion.

The processing system may be further configured to analyze the image of the user to detect the occurrence of the attention cue by the user, the analyzing including providing the image of the user as input to an attention cue identification model, the attention cue identification model trained on a set of images annotated with respective attention cue information of respective subjects, and receiving, as output from the attention cue identification model, an indication of the occurrence of the attention cue by the user.

The electronic device may further include a movable structure representative of a facial feature, and determining the device motion may include determining a motion of the movable structure that is indicative of attention being directed to the user.

The actuation system may include a propulsion system configured to move the electronic device within its surroundings, determining the device motion may include determining a motion of the electronic device that orients a front of the electronic device towards the user, and causing the actuation system to produce the selected device motion may include causing the propulsion system to move the electronic device to orient the front of the electronic device towards the user. Determining the device motion may further include determining a location of the user relative to the front of the electronic device.

The electronic device may further include an articulatable member, the actuation system may be configured to move the articulatable member, determining the device motion may include selecting a motion of the articulatable member from a set of candidate motions, and causing the actuation system to produce the selected device motion may include causing the actuation system to move the articulatable member in accordance with the selected motion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an emotive assistant in a standby mode;

FIGS. 2A-2B show the emotive assistant of FIG. 1, illustrating a first type of device motion of an emotive assistant;

FIG. 3 shows the emotive assistant of FIG. 1, illustrating a second type of device motion of an emotive assistant;

FIG. 4 shows the emotive assistant of FIG. 1, illustrating a third type of device motion of an emotive assistant;

FIGS. 5A-5D show the emotive assistant of FIG. 1, illustrating additional types of device motion of an emotive assistant;

FIGS. 6A-6C show an example interaction between a user and the emotive assistant of FIG. 1;

FIGS. 7A-7B show another example interaction between a user and the emotive assistant of FIG. 1;

FIGS. 8A-8B show another example interaction between a user and another example emotive assistant;

FIGS. 9A-11B show additional examples of device motion for an emotive assistant;

FIGS. 12A-12D show an emotive assistant with a display for producing graphical information;

FIGS. 13-14 are flowcharts showing example operations of an example emotive assistant; and

FIG. 15 is a system diagram of the components of an example emotive assistant.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Some modern electronic devices take the form of electronic companions that are capable of engaging or interacting with humans in various ways. For example, such devices may have multi-modal input capabilities that can detect various types of user inputs or actions, as well as multi-modal output capabilities that can provide information to a user in various different ways. For example, an electronic device may include audio input systems that can detect voice and/or sound inputs, and image input systems that can detect a user’s movements, expressions, location, or other spatial information. The electronic device may further include various output systems, such as an audio output system that can produce sound outputs, a visual output system (e.g., a display, lights, etc.) that can produce visual outputs. The electronic device may also include actuation systems that can provide motion- or movement-based outputs. For example, a propulsion system may allow the electronic device to move in a manner that conveys information to a user. Similarly, a device may move an articulatable member or other movable structure in a manner that conveys information to a user.

As described herein, electronic devices with such varied input and output modalities may be employed as electronic companions. Electronic companions may perform functions including: facilitating search queries and returning relevant information; scheduling calendar items such as tasks, reminders, and meetings; receiving, initiating, and/or transmitting communications to or from another person; health monitoring; executing user commands; executing applications; communicating with and/or controlling other devices (including providing information to other device(s) to facilitate or initiate further processing and/or operations on the other device(s)), and so on. Since the functionalities of such electronic companions often rely on the ability to communicate and engage with a user, described herein are unique ways in which an electronic companion (or other electronic device more generally) may use its input and output systems to detect and respond to a human’s attention cues, and to produce device motion that indicates, to a user, a state of the device (e.g., the “attention” state of the device). Due to the nature with which the electronic devices described herein respond to a user’s attention cues (and respond with its own attention cues), the electronic devices described herein may operate as (and are referred to herein as) “emotive assistants.”

Emotive assistants, as described herein, provide primary information in response to a user command. Examples of primary information include responses to search queries, calendar appointments, electronic messages initiated or received by the electronic assistant, and so on. Essentially, any data generated by, retrieved by, or received by the emotive assistant in response to a user command is primary information. “Contextual information,” by contrast, includes outputs generated by the emotive assistant in order to convey to a user and/or viewer some quality of the primary information. An emotive assistant may convey different types of contextual information. For example, the contextual information may indicate a measure of accuracy, reliability, certainty (e.g., a determination of how closely actual information or task performance matches expected information or task performance), time taken to perform a task, and so on. The emotive assistant may convey contextual information in a variety of ways including visually and/or audibly. Typically, but not necessarily, the contextual information is not simply a verbal or visual recitation of the information itself. Generally, the contextual information is non-verbal in nature. Contextual information may be conveyed, for example, by particular motion(s) of the emotive assistant or portions of the emotive assistant.

The emotive assistant may also detect and respond to attention cues from a user, and may produce its own attention cues as output to the user. For example, the emotive assistant may be configured to capture and analyze images (e.g., still or video images) from its environment, and determine when a user has made a gesture, motion, expression, or other indicator that the user has directed its attention towards the emotive assistant (suggesting that the user wishes to engage the emotive assistant). Upon detecting such indicator, the emotive assistant may respond in some way, indicating that it has recognized the attention of the user and has entered into an interactive mode or has otherwise become receptive to further interaction with the user. In this way, the emotive assistant may act in an engaging, human-like manner towards the user. As used herein, an attention cue may refer to a movement that is produced for the purpose of and/or with the effect of capturing the attention of a user or an emotive assistant for the purpose of initiating an interaction. Example attention cues from a user may be hand gestures, body movements, facial expressions, head movements, gaze directions and changes, physical interactions with the emotive assistant (e.g., touching the emotive assistant), and the like, while example attention cues from an emotive assistant may be movements of the device and/or of movable structures of the device (e.g., articulatable arms, representations of facial features, movable camera lenses, movable and/or rotatable body structures, movable covers (e.g., lens covers), etc.). Thus, attention cues may be used to initiate an interaction between the emotive assistant and a user, such that the user or the emotive assistant may subsequently provide or elicit further information during the interaction. Generally and broadly, interactions between the user and the emotive assistant may correspond or relate to the use or execution of any functionality provided by the emotive assistant.

In some cases, in response to detecting a user’s attention cue or in response to another condition, the emotive assistant may produce an output that is configured to invoke a user’s attention. For example, the emotive assistant may detect a condition or event for which it requires the user’s attention in order to convey some information (e.g., an upcoming event for which the user is to be reminded). In order to capture the user’s attention to convey the reminder, the emotive assistant may attempt to capture the user’s attention by moving into the field of view of the user, or by moving a movable structure (e.g., an arm, a representation of an eye or facial feature, a camera, a body structure or component, etc.) in a manner that invites the user to direct its attention to the emotive assistant. As another example, the emotive assistant may produce an output that indicates an “attention” state of the device towards the user. For example, if a user addresses the emotive assistant (e.g., verbally, or with a nonverbal gesture or attention cue), the emotive assistant may respond with a device motion that indicates its attention towards the user (e.g., a motion indicating that it has detected the user’s intent and that it is in a state to receive further instructions or input from the user).

As used herein, device motion encompasses various types of motions and/or movements of a device. Device motion can include bodily movements of the device (e.g., the device translating, rotating, rolling, flying, etc.), as well as movements of device components or structures, such as articulatable and/or rotatable housing structures, arms, representations of facial features, movable cameras and/or camera lenses, covers or protective structures (e.g., a camera cover), or the like.

By responding to attention cues and producing motion-based attention cues (as well as other types of attention cues, such as visual, audible, etc.), the emotive assistant can engage with a user in a more natural, human-like manner. Moreover, the emotive assistant can be responsive to a greater range of inputs, and provide a greater range of outputs, than conventional electronic devices.

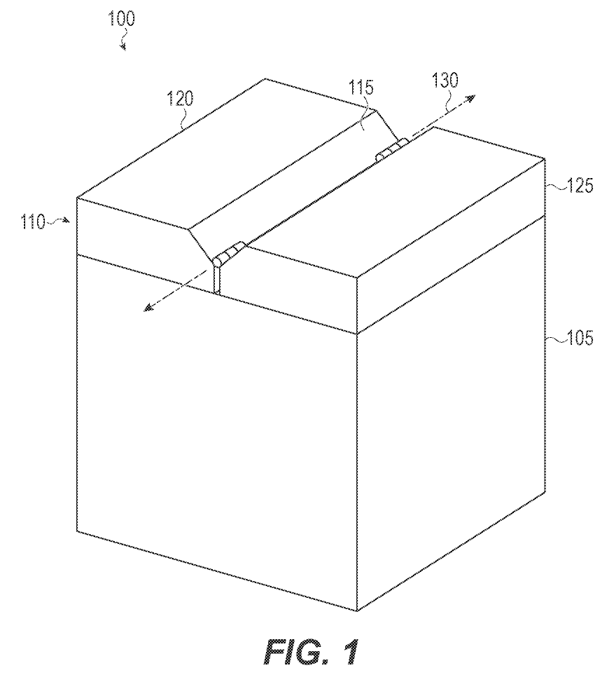

These and other embodiments are discussed below with reference to FIGS. 1-15. However, those skilled in the art will readily appreciate that the detailed description given herein with respect to these Figures is for explanatory purposes only and should not be construed as limiting.

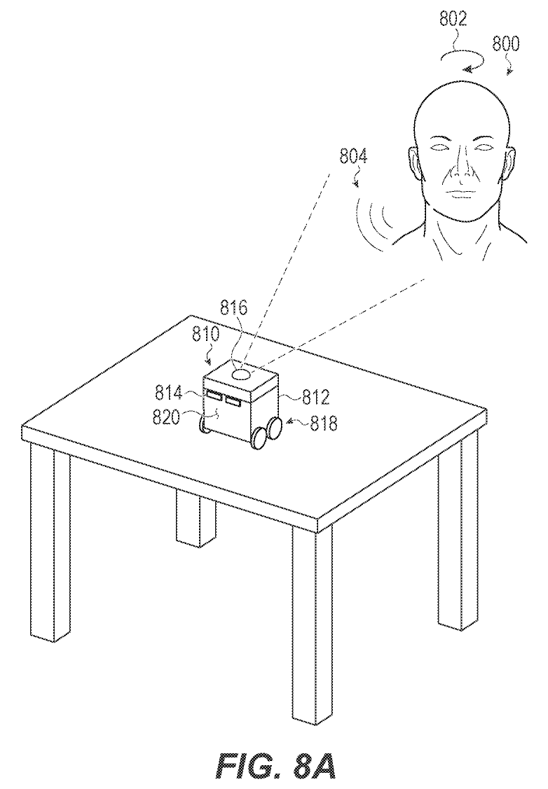

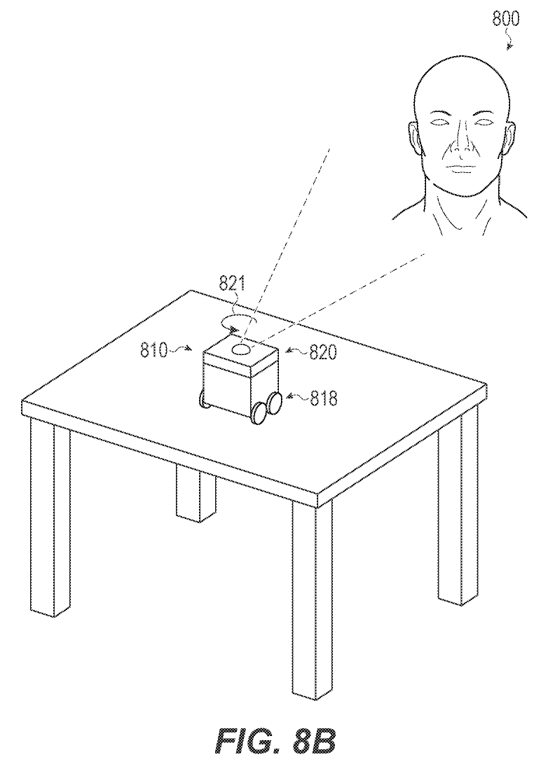

FIG. 1 shows an example emotive assistant 100 in a standby or rest mode. This is merely one example of an emotive assistant that may employ the functionality described herein. Other nonlimiting examples of emotive assistants are described with respect to FIGS. 8A-12D.

The emotive assistant 100 includes a body structure, which may be formed of a base 105 and a head 110. As described herein, the head 110 may be articulatable relative to the base 105. As shown in FIG. 1, the emotive assistant 100 is closed although its base 105 and head 110 are still visible. As can be seen, in this particular embodiment the head is divided into first and second head sections 120, 125 by a seam. A channel 115 is defined along the seam and extends onto each of the first and second head sections. The seam permits the first head section 120 to move independently of the second head section 125, and vice versa. A width of the channel sets the maximum distance each head section can rotate about an axis defined along the seam (the “head axis” 130). That is, since the head axis 130 is not coplanar with an upper surface of the head 110, as viewed with respect to the orientation shown in FIG. 1, the channel width determines at what point during axial rotation the first head section’s upper surface will contact the second head section’s upper surface, thereby preventing further axial rotation of either section. As described herein, movements of the head 110 and the head sections 120, 125 may be used to produce attention cues and/or respond to attention cues from a user.

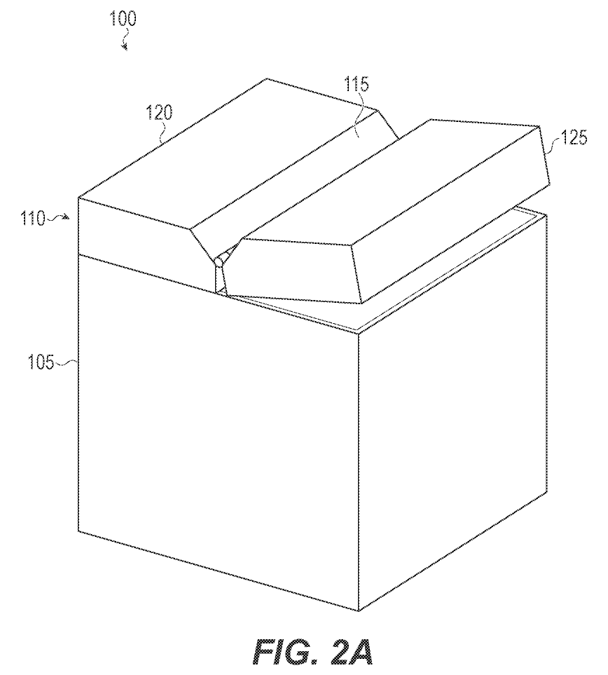

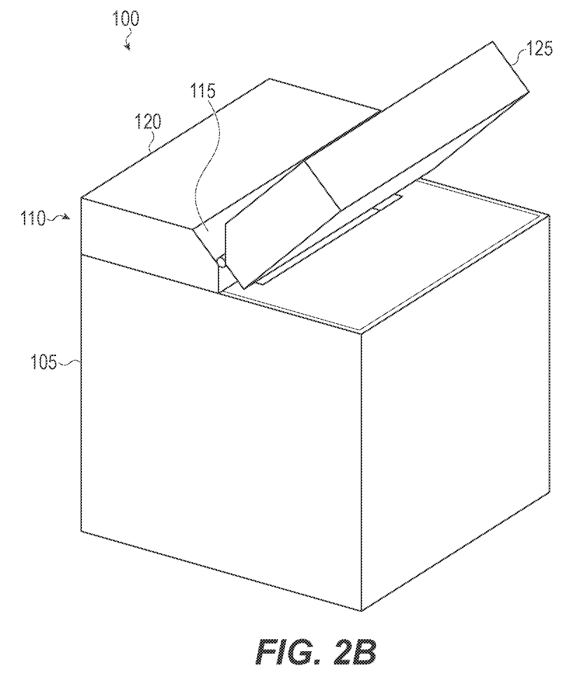

FIGS. 2A-5D illustrate various example device motions and articulations that the emotive assistant 100 is capable of producing, and more generally illustrates an example configuration of the emotive assistant 100. For example, FIG. 2A illustrates the emotive assistant 100 with the head section 125 rotated a relatively small amount relative to the base 105 (e.g., between about 5 and about 20 degrees). FIG. 2B illustrates the emotive assistant 100 with the head section 125 rotated a greater amount relative to the base 105 (e.g., between about 30 and about 60 degrees).

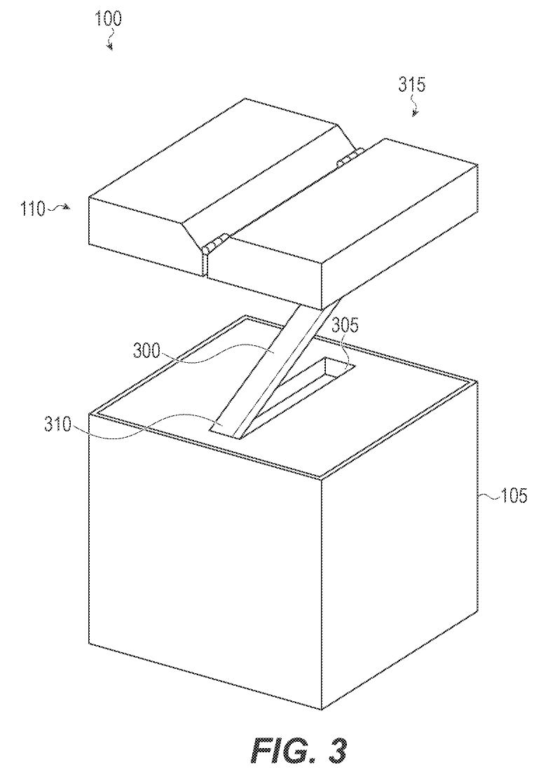

Additionally, as illustrated in FIG. 3, the head 110 may move away from the base 105 (e.g., vertically) in addition to rotating about the head axis 130 (FIG. 1). An arm 300 is connected to the head 110 by a head pivot 315 and to the base 105 by a base pivot 310. The arm 300 can rotate about the base pivot within a single plane or multiple planes. This rotation moves the head 110 relative to the base 105 as the arm 300 is fixed to both the head and the base and (at least in this embodiment) is of a rigid, fixed length. Accordingly, as the arm rotates, the emotive assistant “opens” in that the head moves away from the body, exposing surfaces of the assistant that were concealed while it was in the standby position. In some embodiments, the arm may have multiple degrees of freedom. A base receptacle 305 receives the arm 300 when the emotive assistant 100 is in the standby position of FIG. 1, such that the arm is fully or substantially fully positioned within the base receptacle. As the arm rotates, much of its length exits the base receptacle although a base end of the arm remains in the base receptacle insofar as the base pivot is within the base receptacle.

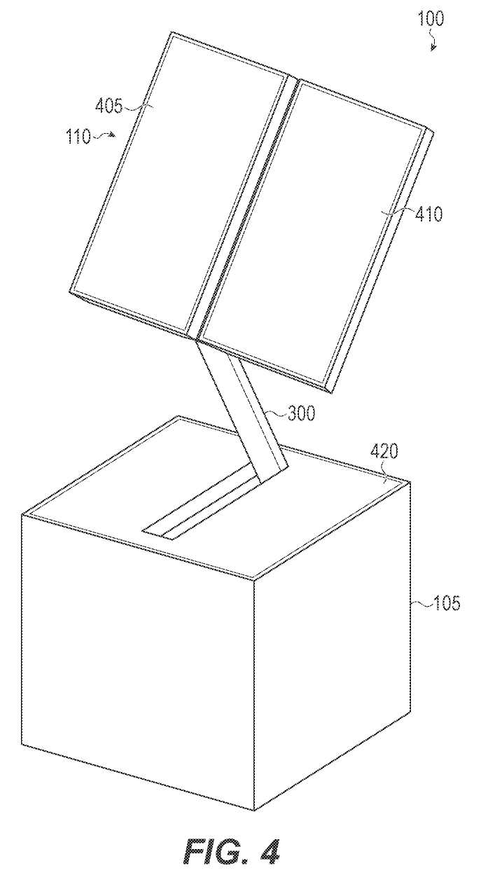

FIG. 4 illustrates another articulation of the emotive assistant 100, in which the head 110 is raised and a “display side” of the head is facing outward. Here, the arm 300 is substantially fully extended from the base 105, with the display side of the head 110 substantially in a plane perpendicular to a display side of the base. The display side of the head includes two head displays 405, 410 configured to show graphical information although, in some embodiments, the display side of the head may include a single display or more than two displays. In some cases, the emotive assistant 100 may also include a base display surface 420, which may include one or more displays configured to show graphical information. The first and second head displays 405, 410, as well as the base display 420, are each configured to display graphics, text, textures, or other information, as described herein. In some cases, the displays may include graphics or graphical content that is configured to act as an attention cue or to accompany a motion-based attention cue (e.g., to convey a state of attention or readiness to the user, or to capture the user’s attention).

These (and other) device motions may be produced in response to detecting an attention cue from a user, and/or to capture the user’s attention (e.g., so that the emotive assistant 100 can provide further information to the user or elicit information from the user). Of course, the concepts described herein may be applied to devices having other configurations, shapes, movable structures, and/or motion capabilities. It will be understood that the principles and concepts described herein may be implemented by and/or are generally applicable to such devices. More particularly, the type of device motion that is used to respond to an attention cue or to act as an attention cue may be determined by the motion capabilities of the particular device that is implementing the motion.

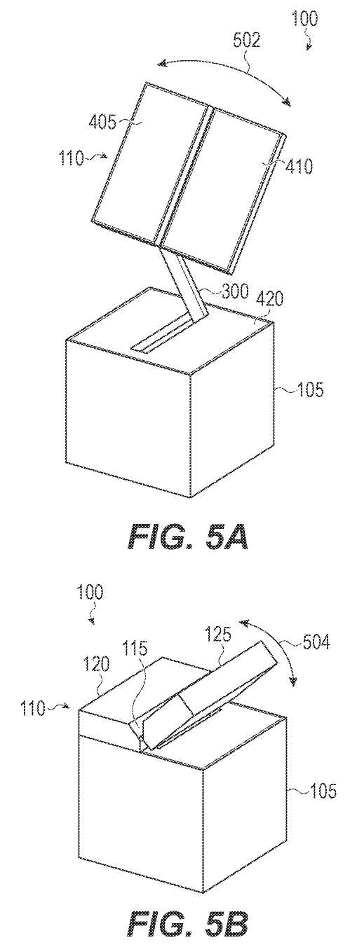

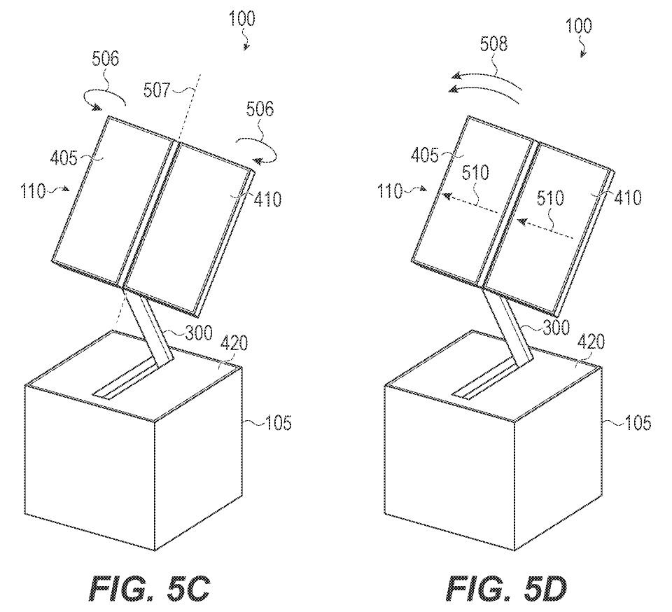

While FIGS. 2A-4 illustrate an example device structure and the general movements of which the emotive assistant 100 is capable, FIGS. 5A-5D illustrate several other specific device movements that may be used to convey or capture attention. In some cases, these movements may be used as attention cues to attempt to capture the user’s attention. As such, they may be repeated continuously or periodically until the emotive assistant 100 detects that the user has directed its attention to the emotive assistant 100. As described herein, such detection may correspond to the emotive assistant 100 detecting a responsive attention cue from the user, which may be a gesture, a movement, a voice response, or the like.

FIG. 5A illustrates the emotive assistant 100 rotating, rocking, or waving its raised head 110 about an axis (as indicated by arrow 502). FIG. 5B illustrates the emotive assistant 100 partially opening and closing (or lifting and lowering) a head section 125 (as indicated by arrow 504). FIG. 5C illustrates the emotive assistant 100 rotating its head displays 405, 410 (and/or head sections) relative to one another about axis 507 (as indicated by arrows 506). The particular motion parameters of these device motions may be selected and optionally dynamically modified by the emotive assistant 100 based on various factors. Example motion parameters that may be selected and/or adjusted include, without limitation, the speed or rate of the motions, the magnitude of the motions, the number of repetitions of the device motion, and the duration of the motions. In some cases, the emotive assistant 100 may select more dramatic motions (e.g., faster, greater magnitude, longer duration) for higher-urgency alerts (e.g., for imminent events or appointments, or incoming messages from important or known sources), and less dramatic motions for lower-urgency alerts (e.g., low-importance events, such as shopping list reminders). In some cases, the emotive assistant 100 may increase the urgency of the motions until the emotive assistant 100 detects that the user has turned its attention to or otherwise acknowledged the emotive assistant’s attention cue. It will be appreciated that these examples are nonlimiting, and the motion parameters may be scaled or selected based on any suitable factors, such as time of day, the type of information to be conveyed to or elicited from the user, the identity of a sender of a message, the identity of the application or service that initiated the request, or the like.

FIG. 5D illustrates another type of device motion that may be used in an attention-based communication paradigm. In particular, in some cases, as part of an interaction with a user, it may be desirable for the emotive assistant to direct a user’s attention elsewhere, such as towards another object, event, or location. In such cases, the emotive assistant may select a motion output that includes a directional component that is designed to provide a directional cue or information towards the location of interest. FIG. 5D illustrates the emotive assistant 100 making a deictic gesture with its head 110, illustrated as a repeated “nod” like motion in a direction (as indicated by arrows 508). The directional component of the deictic gesture may indicate the direction in which the emotive assistant 100 is suggesting that the user look. In some cases, the directional component of the gesture may be reinforced by other visual (or other sensory) outputs, such as arrows 510 displayed on the displays 405, 410. Other examples of reinforcing outputs may include lights (e.g., a strip or array of lights illuminated in a directional sequence), audio outputs, voice outputs, or the like. While FIG. 5D illustrates the head 110 producing the deictic gesture, this is merely one example based on the particular configuration of the emotive assistant 100, and other deictic gestures may also be produced by the emotive assistant 100 or differently configured emotive assistants. For example, a device with a propulsion system (or the ability to rotate, spin, or the like) may make a twisting or rotating motion to indicate a direction, or it may turn and face the direction toward which the user is to be directed.

In the case of deictic gestures or other outputs with directional components, the emotive assistant 100 may be configured to determine a target location or direction to which the user’s attention is to be directed, as well as a location of the user. The emotive assistant 100 may determine the motion parameters for the deictic gesture based at least in part on the target location for the user’s attention and the location of the user (as well as the location of the emotive assistant 100). The motion parameters may include, for example, a direction in which to move an articulatable member, or a direction towards which the emotive assistant will face, or the like. The location of the user and of the target location for the user’s attention may be determined using sensing systems of the emotive assistant 100, such as imaging systems, ultrasonic sensors, depth sensors, LiDAR sensors, radar sensors, haptic and/or touch-based sensors (e.g., a touch from a user may provide information about the location of the user), and the like. The emotive assistant may also use stored location information, such as room or environment maps, to determine locations of objects or events. As one particular example of a deictic gesture, an emotive assistant 100 may detect the presence of a visitor at a door (e.g., via a communicatively coupled doorbell or camera). In response to detecting the presence of the visitor, the emotive assistant 100 may determine motion parameters for a deictic gesture based on the location of the door, the location of the user, and the location of the emotive assistant. The emotive assistant may then attempt to capture the user’s attention and direct the user’s attention towards the door, such as with the gesture illustrated in FIG. 5D.

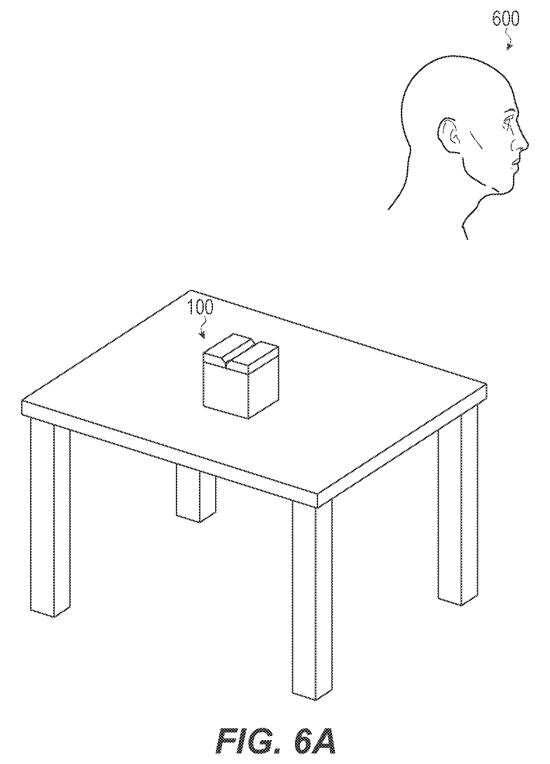

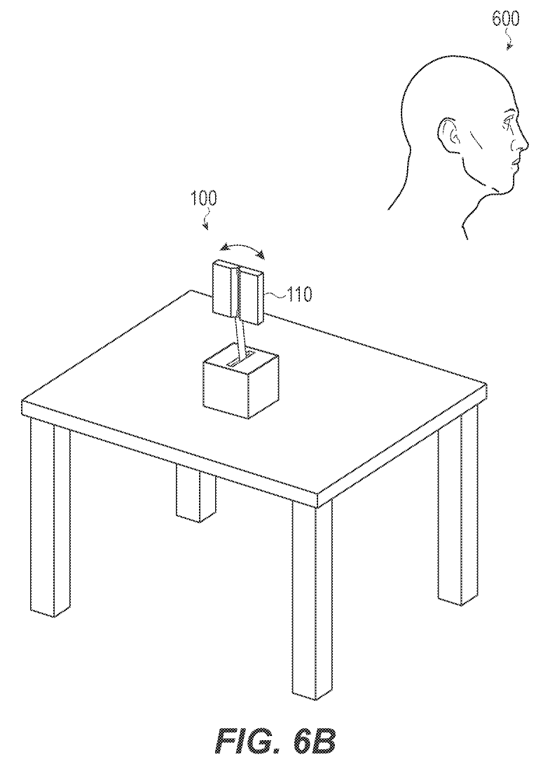

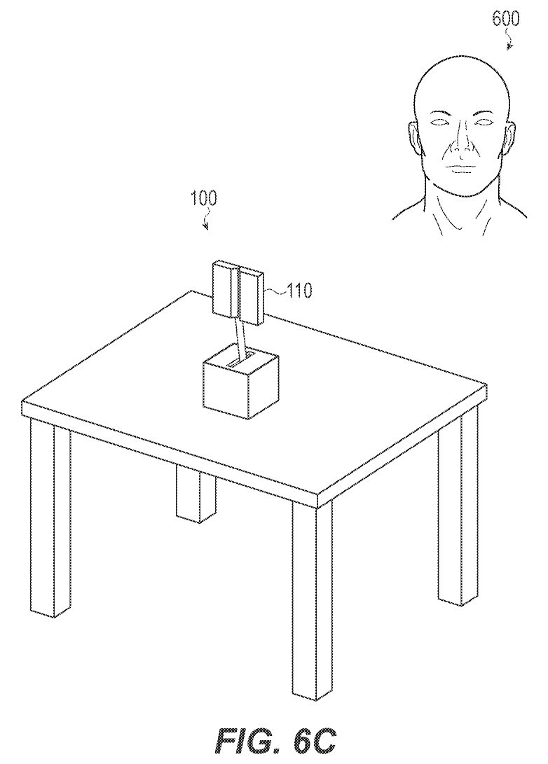

FIGS. 6A-8B illustrate various example interactions between a user and an emotive assistant 100, in which attention cues and other movements are used as input and output modalities between the user and device. FIG. 6A illustrates a user 600 and the emotive assistant 100, where the user’s attention is not focused on the emotive assistant 100, and the emotive assistant 100 is in a standby or rest mode.

While in the standby or rest mode (or even while the device is in another state), the emotive assistant 100 may detect an event associated with information to be conveyed to the user. The event may correspond to any type of event, alert, communication, information, or the like, that is configured to initiate an interaction with the user in order to convey information to the user. Example events include, without limitation, incoming communications (e.g., emails, text messages, voice or video calls, voice memos), calendar or task reminders (or other reminders), application alerts (e.g., communications issued by applications or computer programs, executed by the emotive assistant or another device), user-selected alarms or timers, physical events or conditions (e.g., detecting an arrival of a visitor, a ring at the doorbell, an unlocked door, etc.), or the like.

In response to detecting the event, the emotive assistant 100 may select a device motion that is configured to capture the user’s attention. The device motion may be selected from a set of candidate device motions. For example, the emotive assistant 100 may include a set of at least partially preprogrammed candidate device motions (e.g., the motions described with respect to FIGS. 5A-5D and 9A-11B, or other motions of which an emotive assistant is capable). The emotive assistant 100 may select a device motion based on various factors, such as the location of the user relative to the emotive assistant 100, the distance between the user and the emotive assistant 100, the current state or status of the user, attention cue history (e.g., whether the emotive assistant 100 has already attempted to capture the user’s attention), and the like. Once a device motion is selected, the emotive assistant 100 may also select or modify the motion parameters for a selected device motion using the same or similar factors, as described herein.

In some cases, the association between the above-mentioned factors and different candidate device motions (and the parameters of the device motion) may be programmatically determined based on a principle of using the least disruptive or intrusive motion that is needed for a given circumstance. Thus, for example, if the user is quiet and still (suggesting that a slight movement of the device will be noticeable), the emotive assistant 100 may select a more subtle device motion (e.g., the lid motion in FIG. 5B), and may select less dramatic motion parameters (e.g., slower and/or lower-magnitude movements). As another example, if the user is moving within the environment or the emotive assistant 100 otherwise determines that a more substantial movement is warranted, the emotive assistant 100 may select a different motion (e.g., the head shake movement in FIG. 5A).

In examples where the emotive assistant includes an articulatable member (e.g., the head 110, or other articulatable members as described herein), the candidate device motions may include a set of candidate motions of the articulatable member. Where the emotive assistant is capable of other motions, such as translations, rotations, or other motions produced by a propulsion system or the like, such motions may be included in the candidate device motions.

Candidate device motions may be fully preprogrammed or partially preprogrammed. Fully preprogrammed device motions may include all motion parameters of the device motion. For example, a fully preprogrammed device motion may correspond to the emotive assistant 100 moving its head 110 a certain distance at a certain speed. Fully preprogrammed device motions may be used without selection or modification of motion parameters (e.g., speed, magnitude, repetitions, duration, etc.) of the device motion.

Partially preprogrammed device motions may include a general specification of a motion type, and may include one or more variable or selectable motion parameters. For example, a partially preprogrammed device motion for the emotive assistant 100 may include a motion path for the head 110, but may not specify the speed of the motion (or the magnitude, duration, repetitions, or other motion parameter). In such cases, the emotive assistant 100 may select the value of the variable or selectable motion parameter based on factors such as the location of the user relative to the emotive assistant 100, the distance between the user and the emotive assistant 100, the current state or status of the user, environmental conditions (e.g., a level of ambient sound, an amount of motion occurring in the environment, lighting conditions, etc.), attention cue history (e.g., whether the emotive assistant 100 has already attempted to capture the user’s attention), and the like.

In some cases, device motion specifications or definitions may include default values for the motion parameters, and the default values may be used without modification (e.g., as a fully preprogrammed device motion), or they may be modified and/or selected to customize the device motion (e.g., to select the speed, magnitude, duration, repetitions, etc.). The values of the motion parameters may be determined in the same or similar manner as described above with respect to the partially preprogrammed device motions.

In yet another example, device motions may be generated dynamically, rather than being selected from a set of candidate device motions. For example, the emotive assistant 100 may include a motion generation engine that is configured to dynamically produce device motion specifications. The motion generation engine may be configured to accept, as inputs, information from one or more systems and/or sensors of the emotive assistant 100, and generate, as output, a motion specification for the emotive assistant 100 (e.g., one or more device motions and associated motion parameters that define the device motion). The inputs may include, without limitation, a location of the user relative to the emotive assistant 100, the distance between the user and the emotive assistant 100, the current state or status of the user, environmental conditions (e.g., a level of ambient sound, an amount of motion occurring in the environment, lighting conditions, etc.), attention cue history (e.g., whether the emotive assistant 100 has already attempted to capture the user’s attention), information about an event that initiated the selection of the device motion (e.g., information about an attention cue detected from a user, text from a voice input issued by a user, etc.), and the like. The motion generation engine may also accept as input (or may be prepopulated with) a specification or definition of the motion systems of the device, including the types of motions that can be produced, the available motion parameters for a given actuator or actuation system, or the like. Using these inputs and/or specifications, the motion generation engine may generate device motions, in real time, in response to particular events. As one particular nonlimiting example, a motion generation engine may be provided with a prompt that requests a motion for a device having a head portion 110 that can be swiveled about an axis and articulated by an arm, where the motion is to be generated in a quiet environment with a user within 10 feet, and where the motion is intended to capture the user’s attention about an urgent matter. In response to the prompt, the motion generation engine may generate a specification of a device motion, including any relevant motion parameters and/or specifications for the various actuators and/or articulation systems of the device. The emotive assistant 100 may then execute the dynamically generated device motion.

In some cases, the motion generation engine may be or may include a generative model that generates novel outputs to a prompt based at least in part on identifying patterns in a set of reference data. The reference data may include, for example, images and/or videos of individuals or objects moving in response to certain events and/or other stimuli.

In some cases, the motion generation engine may be or may include a machine learning model that is trained using sets of images and/or videos of individuals or objects moving in response to certain events and/or other stimuli. Thusly trained, the machine learning model may accept inputs as described above (e.g., a prompt, environmental status, location of user, etc.), and provide, as output, a motion specification.

Once the emotive assistant 100 has selected the device motion that is configured to capture the user’s attention, the emotive assistant 100 may cause an actuation system of the device to produce the selected device motion. FIG. 6B illustrates the emotive assistant 100 producing the selected device motion. In this example, the emotive assistant 100 is producing a head shake motion (e.g., illustrated in FIG. 5A). More particularly, the emotive assistant 100 includes an articulatable member (e.g., the head 110 on the arm 300, FIG. 3), and an actuation system that is configured to move the articulatable member. The emotive assistant 100 may cause the actuation system to produce the selected device motion by moving the articulable member in accordance with the selected device motion and motion parameters. As described herein, the actuation system may include motors, actuators, gear systems, linkages, and any other components that can produce device motion, such as those described herein or other device motions. The actuation system may be responsive to instructions from a processing system, which may select device motions and motion parameters, and ultimately cause the actuation systems to produce the device motion(s) according to the selected parameters. In some cases, the actuation system may be or may include a propulsion system, and causing the actuation system to produce the selected device motion includes causing the propulsion system to move the emotive assistant within its surroundings (as shown, for example, in FIGS. 8A-8B).

In order to provide a socially appropriate interaction, it may be desirable for the emotive assistant 100 to cease producing the device motion once the user has acknowledged the emotive assistant 100. Thus, after the emotive assistant 100 has initiated the device motion, the emotive assistant 100 may monitor the user for indications that the user has directed its attention towards the emotive assistant 100. For example, the emotive assistant 100 may capture an image of the user (still and/or video image) with an image capture system. The image capture system may be or may include a camera physically integrated with the emotive assistant 100 (or a remote camera that is operably coupled to the emotive assistant 100). The emotive assistant 100 may analyze the image of the user to determine an attention state of the user, and in accordance with a determination that the attention state of the user is indicative of attention being directed to the emotive assistant 100, cause the actuation system to cease producing the selected device motion. FIG. 6C illustrates the user 600 having turned their head and directed their gaze towards the emotive assistant 100, indicating that they have directed their attention towards the emotive assistant 100. In response, the emotive assistant 100 ceases the device motion, and may proceed to convey the information that is associated with the event that resulted in the emotive assistant 100 issuing the attention cue. Thus, for example, the emotive assistant 100 may produce audio or visual output to convey the information.

The emotive assistant 100 may analyze the image of the user in various ways in order to determine whether the user has directed their attention towards the emotive assistant 100. As one example, the emotive assistant 100 may provide the image of the user as input to an attention identification model, where the attention identification model is trained on a set of images annotated with respective attention state information of respective subjects. The attention identification model may then provide, as output, an indication of the attention state of the user. For example, an attention identification model may be or may include a machine learning model that is trained using sets of images of people, where the images are annotated with information regarding the attention state of the person in the image. Thusly trained, the machine learning model may accept, as inputs, images (e.g., still images, video images), and provide, as output, an indication of the attention state of the user. In some cases, the indication may take the form of a binary result indicating whether the user’s attention is directed to the emotive assistant 100. In other cases, the indication may take the form of a score indicating a likelihood or prediction that the user’s attention is directed to the emotive assistant 100 (e.g., a score between 0-10, with 10 indicating a highest likelihood). Other outputs indicating the attention state of the user are also contemplated.

As another example, the emotive assistant 100 may use a gaze tracking system to determine whether the user has directed their attention towards the emotive assistant 100. For example, the emotive assistant 100 may analyze the captured image of the user (or other acquired data) to determine or estimate the gaze direction of the user. If the gaze direction is directed to the emotive assistant 100 (and/or if a change in the gaze direction towards the emotive assistant 100 is detected), the emotive assistant 100 may determine that the user has directed their attention towards the emotive assistant 100.

In some cases, if the device motion is not effective in capturing the user’s attention, the emotive assistant 100 may escalate the device motion. For example, if the emotive assistant 100 determines (while producing the device motion or after ceasing an initial device motion) that the user has not directed their attention towards the emotive assistant 100, the emotive assistant 100 may select an alternative device motion, and cause the actuation system to produce the alternative device motion. The alternative device motion may correspond to an entirely different motion type, or different motion parameters for the same motion type. For example, the emotive assistant 100 may transition from the lid motion (FIG. 5B) to a head shake motion (FIG. 5A), or it may increase the speed or magnitude of the lid motion. In some cases, the emotive assistant 100 may continue to escalate the motion parameters or transition between motion types until the it detects that the user’s attention has been directed towards the emotive assistant 100, or another condition is satisfied (e.g., the user interacts with the emotive assistant 100 in another way, such as via voice command or physical interaction, or an alert timeout condition is reached).

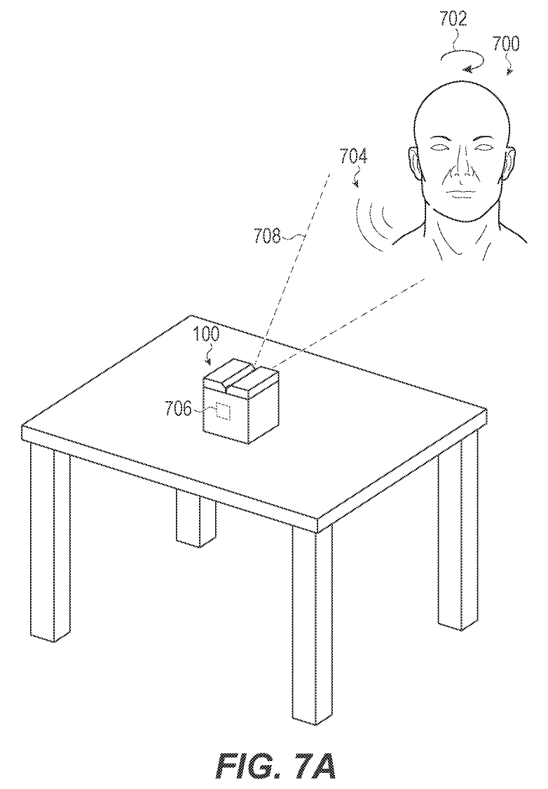

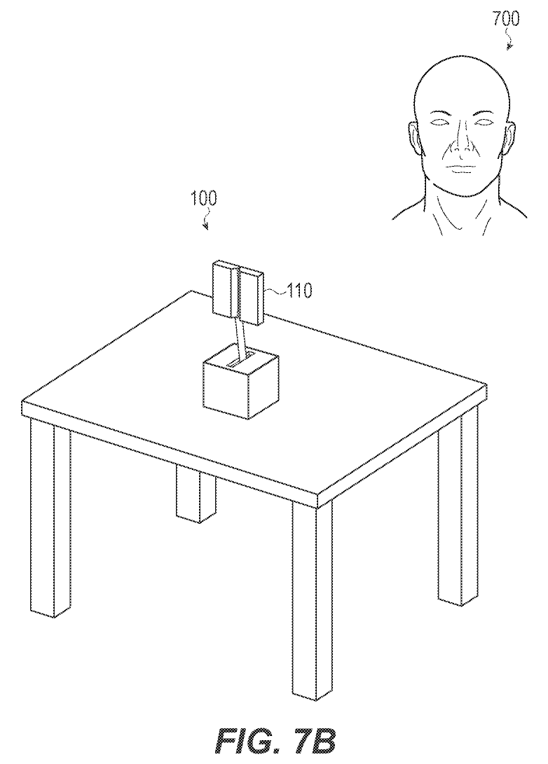

As described herein, attention cues may be used by both an emotive assistant and a user during or to initiate (or terminate) interactions between the emotive assistant and the user. FIGS. 6A-6C, for example, illustrate an emotive assistant 100 using an attention cue in order to capture the attention of the user. FIGS. 7A-7B illustrate an emotive assistant 100 detecting and responding to an attention cue from the user. For example, an emotive assistant 100 that is in a standby or rest mode may monitor for attention cues from a user, and respond with a motion or other responsive action that indicates, to the user, that it has recognized the user’s cue and is in an interactive mode or is otherwise ready to receive inputs from the user.

As used herein, an interactive mode of an emotive assistant may correspond to a mode in which a set of interactive functionalities of the emotive assistant is available to the user. For example, in the interactive mode, all or substantially all of the emotive assistant’s interactive functionality may be immediately accessible to the user, such that a user may make requests and the emotive assistant may respond to the requests without further device initiation or wake sequences. As described herein, the emotive assistant may enter into an interactive mode in response to a user request, or in response to a detected condition or event, such as when the emotive assistant detects an alert and, in response, attempts to capture the user’s attention to convey information about the alert. An interactive mode may be contrasted with a standby or rest mode. In particular, in the standby or rest mode, the emotive assistant may only respond to a subset of stimuli or inputs. For example, the emotive assistant may only respond to attention cues, trigger or “wake” words or phrases, physical inputs (e.g., tapping or touching the emotive assistant, pressing a button, etc.), or the like. In response to receiving such stimuli or input, the emotive assistant may transition from the standby or rest mode to the interactive mode. In some cases, the interactive mode may be distinguished from a standby or rest mode by the types of inputs that the emotive assistant will respond to—in the standby or rest mode, the emotive assistant may respond only to certain inputs that it is otherwise capable of responding to, and in the interactive mode, the emotive assistant may respond to a greater scope of inputs (such as all of the input types that it is capable of responding to.

FIG. 7A illustrates the emotive assistant 100, which may be in a standby or rest mode. The emotive assistant 100 may include an image capture system that is configured to capture an image of the user 700 (e.g., a video or still image), represented by field of view 708. The emotive assistant 100 may analyze the image of the user to detect an occurrence of an attention cue from the user. Analyzing the image may include providing the image of the user as input to an attention cue identification model, and receiving, as output from the attention cue identification model, an indication of the occurrence of the attention cue by the user. The attention cue identification model may be trained on a set of images annotated with respective attention cue information of respective subjects. For example, an attention cue identification model may be or may include a machine learning model that is trained using sets of images of people, where the images are annotated with information regarding the presence or occurrence (and/or absence of) of a person performing an attention cue in the image. Thusly trained, the machine learning model may accept, as inputs, images (e.g., still images, video images), and provide, as output, an indication of whether an attention cue has occurred or been performed. In some cases, the indication may take the form of a binary result indicating whether an attention cue has been performed. In other cases, the indication may take the form of a score indicating a likelihood or prediction that an attention cue has been performed (e.g., a score between 0-10, with 10 indicating a highest likelihood). Other outputs indicating the occurrence or nonoccurrence of an attention cue are also contemplated.

As shown in FIG. 7A, the attention cue may correspond to the user 700 moving their head such that they are facing the emotive assistant 100 (as indicated by arrow 702). In other examples, the attention cue may be a user directing their gaze towards the emotive assistant 100. In yet other examples, the attention cue may be an audible or voice-based attention cue 704 (in which case the emotive assistant 100 may detect the attention cue using an audio sensing system).

In response to detecting the occurrence of the attention cue, the emotive assistant 100 may select a device motion configured to indicate that the emotive assistant 100 has detected the attention cue and that the emotive assistant 100 has entered an interactive mode, and may cause an actuation system to produce the selected device motion. For example, as shown in FIG. 7B, the emotive assistant 100 has performed a motion corresponding to a raising of the head 110 to face the user 700. When this motion is performed immediately or shortly after a user performs an attention cue directed to the emotive assistant 100, the response may clearly indicate to the user that the emotive assistant 100 has accurately interpreted the user’s intent and is prepared to accept further inputs (e.g., it is in an interactive mode).

The emotive assistant 100 may select the device motion in the same or similar manner as described above. For example, the emotive assistant 100 may include a set of at least partially preprogrammed candidate device motions (e.g., the motions described with respect to FIGS. 5A-5D and 9A-11B). The emotive assistant 100 may select a device motion based on various factors, such as the location of the user relative to the emotive assistant 100, the distance between the user and the emotive assistant 100, the current state or status of the user, and the like. Once a device motion is selected, the emotive assistant 100 may also select or modify the motion parameters for a selected device motion using the same or similar factors, as described herein.

In cases where the emotive assistant 100 is responding to an attention cue from a user (rather than acting as the initiator itself), the emotive assistant 100 may select the device motion and its associated motion parameters in order to generally mirror or match some aspect of the attention cue from the user. In this way, the emotive assistant 100 may produce more natural and human-like interactions. For example, the emotive assistant 100 may detect or otherwise determine characteristics of the user’s attention cue, such as a speed (e.g., a speed at which the user turns their head or body towards the emotive assistant) and/or a magnitude (e.g., a magnitude of the motion, such as a slight raise of the head versus a full body motion). Based on the detected characteristics of the user’s attention cue, the emotive assistant 100 may select a device motion and associated motion parameters to generally mirror or match those characteristics. For example, in response to a slight raise of the head or a slow turn of the user’s head to face the emotive assistant, the emotive assistant 100 may select a more subtle device motion (e.g., the lid motion in FIG. 5B), and may select less dramatic motion parameters (e.g., slower and/or lower-magnitude movements). In response to a more dramatic whole-body motion, the emotive assistant may select a faster, full raise of the head 110 to face the user.

In some cases, an attention cue of a user may be or may include (e.g., in addition to a user motion) an audio output, represented by audio 704, and the emotive assistant 100 may include an audio input system 706 that is configured to receive the audio output from the user. For example, the user may issue a voice command such as “hello” or “got a second?” The voice command may be a predetermined word, phrase, or sound (or any one of a set of words, phrases, or sounds) to which the emotive assistant 100 is programed to respond. Additionally or alternatively, the emotive assistant 100 may be configured to analyze audio outputs from the user and determine whether the audio output is an attention cue (e.g., is indicative of a request to interact with the emotive assistant 100). For example, the emotive assistant 100 may include or be associated with a semantic processing engine that accepts the audio output, and provides, as output, an indication of whether the audio corresponds to an attention cue. In response to determining that the audio output corresponds to an attention cue, the emotive assistant 100 may select a responsive device motion, as described herein.

FIGS. 6A-7B illustrate example device motions of the emotive assistant 100, showing example motions of the head 110 relative to the base 105. FIGS. 8A-8B illustrate another example emotive assistant 810 detecting and responding to an attention cue from a user 800. The emotive assistant 810 includes a body structure 812, articulatable members 814, a propulsion system 818, and an input system 816 (which may include image and audio capture systems).

The articulatable members 814 may be positioned on (or define) a front 820 of the emotive assistant 810. The articulatable members 814 may have an appearance and may be capable of motions that mimic or are evocative of human features, such as eyebrows. The propulsion system 818 may include wheels and associated motor(s) and any other systems that can propel or otherwise move the emotive assistant 810 within its environment.

As shown in FIG. 8A, the emotive assistant 810 may be in a standby or rest mode. The emotive assistant 810 may analyze an image of the user and/or detected audio to detect an occurrence of an attention cue from the user, as described herein (e.g., to determine whether a user’s motion 802 and/or audio output 804 are indicative of a request to initiate an interaction with the emotive assistant 810). In response to detecting the occurrence of the attention cue, the emotive assistant 810 may select a device motion configured to indicate that the emotive assistant 810 has detected the attention cue and that the emotive assistant 810 has entered an interactive mode, and may cause an actuation system to produce the selected device motion.

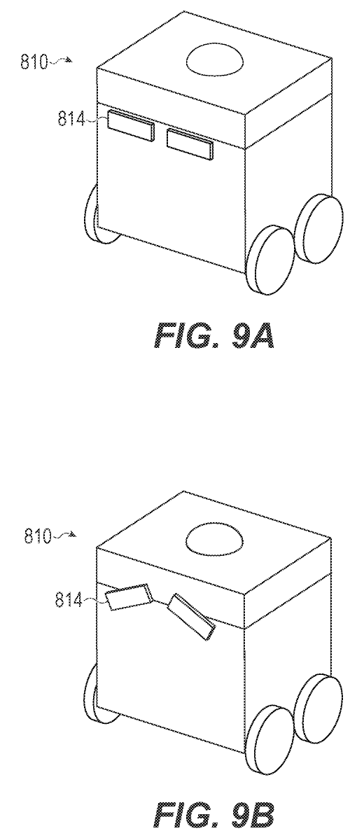

In this example, the emotive assistant 810 may select a device motion that causes the emotive assistant 810 to orient itself so that it is facing the user 800 (e.g., oriented towards the user). Thus, as shown in FIG. 8B, the emotive assistant 810 rotates (arrow 821) so that the front 820 of the emotive assistant 810 is directed towards the user. (In some cases, the emotive assistant may include a display, and the motion may include orienting the display towards the user.) The emotive assistant 810 may further perform additional device motions, such as by moving its articulatable members 814, as described with respect to FIGS. 9A-9B. In cases where the emotive assistant 810 is already facing the user, the emotive assistant 810 may only produce motions of its articulatable members in response to detecting the attention cue. As another example, the emotive assistant 810 may move its body structure in other ways, such as with a side-to-side rotation or back-and-forth motion, which may further indicate the device mode and/or indicate a transition to an interactive mode.

In some cases, the “front” of an emotive assistant may correspond to a side that includes input and/or output systems (e.g., a camera, display, light source, etc.), or other features that indicate or are suggestive of a primary side. For example, a front side may be a side that includes articulatable members that resemble or are evocative of facial features. In cases where the emotive assistant includes a display, lights, a speaker or other audio output system, an input sensing system (e.g., cameras, microphones, etc.), and the like, the locations of such systems may define the front of the emotive assistant.

In order to select the device motion for the propulsion system (or other system that produces bodily motion of the emotive assistant, or of a portion thereof), such as to cause the emotive assistant 810 to orient its front towards the user, the emotive assistant 810 may determine a location of the user relative to the emotive assistant 810 (e.g., via the input system 816), determine a location and orientation of the emotive assistant 810 relative to the user (e.g., via the input system 816 and/or other position and/or location sensors, such as an inertial measurement unit, accelerometer, compass, and the like), and determine motions and motion parameters for the propulsion system that will result in the emotive assistant 810 orienting its front (or other user-facing side) towards the user. The particular motions may include rotations, translations, or any other motion of which the emotive assistant 810 is capable. While device motions with a propulsion system are shown with respect to the emotive assistant 810, the same or similar techniques may be applied to the emotive assistant 100 or to any other emotive assistant that is equipped with a propulsion system.

FIGS. 9A-11B illustrate additional example emotive assistants that include articulatable members and (optionally) propulsion systems, which may be used to produce device motions as described herein. FIGS. 9A-9B illustrate the emotive assistant 810 with the articulatable members 814. FIG. 9A illustrates the articulatable members 814 in a first position, and FIG. 9B illustrates the articulatable members 814 in a second position. This motion, or other motions of the articulatable members 814, may be used as attention cues or to respond to attention cues from a user, as described herein. In this example, the articulatable members 814 may be configured to resemble or be evocative of eyebrows, and may be configured to move in a manner that resembles eyebrow movements. While FIG. 9B illustrates one example motion (e.g., raising the articulatable members 814 at angles), this is merely one example motion that the articulatable members 814 may be capable of.

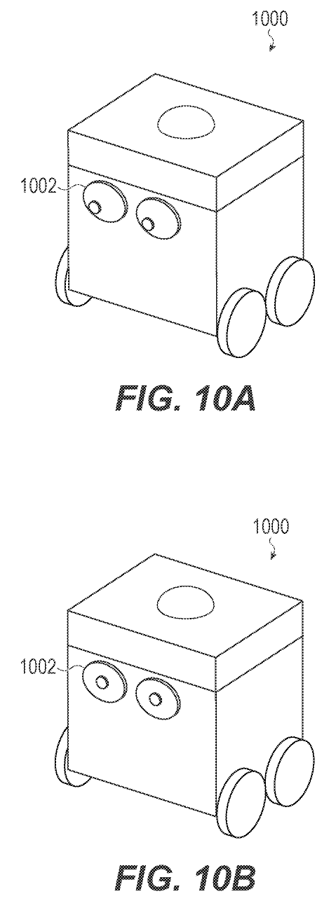

FIGS. 10A-10B illustrate an emotive assistant 1000 that includes articulatable eye members 1002. The articulatable eye members 1002 may resemble an eye, and may have movable elements such as pupils, irises, eyelids, eyebrows, and the like. FIGS. 10A-10B illustrate the eyes moving from a first position to a second position. This motion, or other motions of the articulatable members 1002, may be used as attention cues or to respond to attention cues from a user, as described herein.

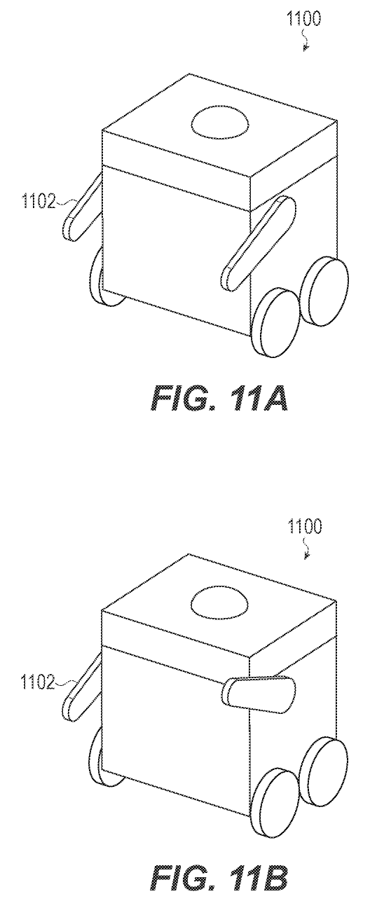

FIGS. 11A-11B illustrate an emotive assistant 1100 that includes articulatable arm members 1102. The articulatable arm members 1102 may resemble human arms. FIGS. 11A-11B illustrate the arm members 1102 moving from a first position to a second position. This motion, or other motions of the articulatable arm members 1102, may be used as attention cues or to respond to attention cues from a user, as described herein.

Any of the motions described herein may be repeated, periodic, cyclic, or otherwise performed more than once to be more noticeable to a user. For example, the arm movement in FIGS. 11A-11B may be repeated to produce a waving motion, which may continue for a predetermined duration and/or until the user directs its attention towards the emotive assistant.

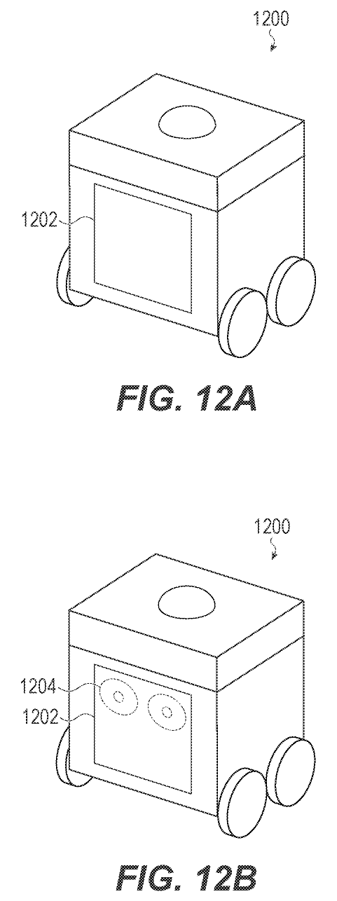

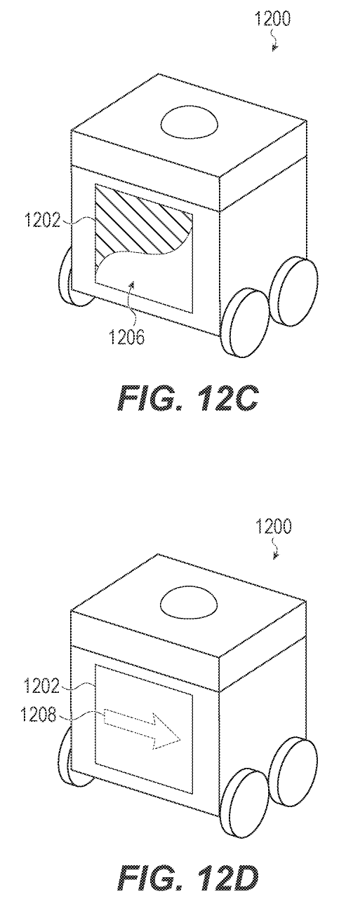

FIGS. 12A-12D illustrate an emotive assistant 1200 that includes a display 1202. The display 1202 may be used to provide visual outputs, and may be provided in addition to (or optionally instead of) any of the articulatable members described herein. The display 1202 is configured to produce graphical outputs. The graphical outputs may be used as attention cues and/or to provide other information. For example, FIG. 12A illustrates the emotive assistant 1200 with a blank or empty display 1202. FIG. 12B illustrates the emotive assistant 1200 displaying eyes 1204. The eyes 1204 (which may be static or animated) may be used to capture a user’s attention (e.g., as an attention cue), or to respond to an attention cue from a user (e.g., to acknowledge the user’s attention cue and indicate that the emotive assistant 1200 has entered an interactive state). In some cases, the appearance of the eyes may be used as an attention cue or a response to an attention cue, and further eye animations may be used to further express information or respond to emotional or other semantic information from a user.

FIG. 12C illustrates the display 1202 depicting a graphic 1206, such as a wash of color or other animation. The appearance and/or animation of the graphic 1206 may be used as an attention cue, a response to an attention cue, or otherwise to indicate a state or status of the emotive assistant. For example, the emotive assistant 1200 may produce the graphic 1206 in order to attempt to capture the attention of the user, or indicate to the user that it has recognized the user’s attention cue.

FIG. 12D illustrates the display 1202 depicting an informational graphic 1208. The informational graphic 1208 may be used to direct a user’s attention to different objects or events within an environment. For example, the emotive assistant 1200 may use an arrow (e.g., a static or animated arrow) to instigate a user to direct its attention in a certain direction. The emotive assistant 1200 may further evaluate the user’s gaze, position, movements, or the like to determine if the user appears to have responded to the graphic 1208, and may modify the graphic in response to the user’s behavior. For example, if the user does not direct their gaze or attention in the indicated direction, the emotive assistant 1200 may cause the graphic to increase in size, blink, flash, or the like, or may add device motion and/or audio outputs. As another example, if the user does respond to the graphic 1208, the emotive assistant 1200 may cease displaying the informational graphic 1208. While the discussion of graphical outputs on a display are described with reference to the example emotive assistant 1200, it will be appreciated that the same discussion applies equally to any emotive assistant with displays, such as the emotive assistant 100 (e.g., the displays 405, 410, 420).

The foregoing examples describe various device motions (and graphical outputs on a display) that may be used as attention cues, to respond to attention cues, or to otherwise interact with a user in an emotionally evocative manner. It will be understood that the device motions described herein may be used alone or in combination with other device motions or other output modalities. For example, an emotive assistant may escalate attention cues by adding or incorporating different device motions. As one specific example, an emotive assistant may initiate a motion cue that includes moving an articulatable member, such as a head 110 (e.g., as shown in FIGS. 5A-5C, or the like). If the user does not respond to the attention cue, the emotive assistant may incorporate another motion, such as a wholesale movement of the emotive assistant (e.g., with a propulsion system). As another example, an emotive assistant may begin an attention cue by moving a single arm (e.g., as shown in FIG. 11A-11B), and if the user does not respond to the cue, the emotive assistant may begin moving a second arm as well.

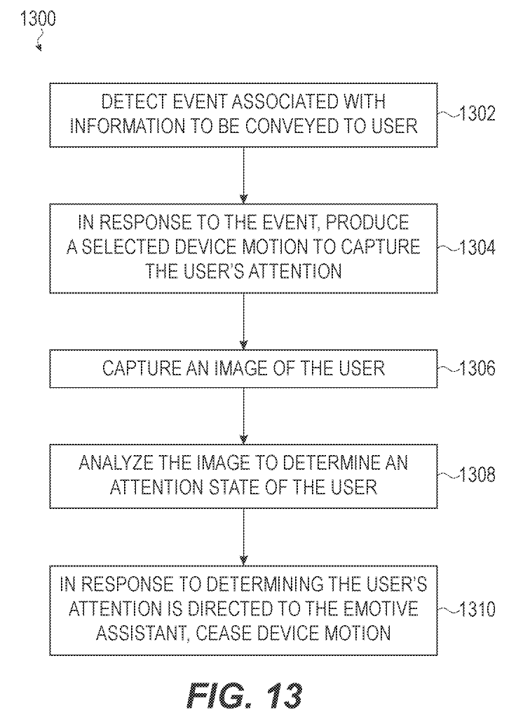

FIG. 13 is a flowchart depicting an example method 1300 by which an emotive assistant may capture a user’s attention using motion outputs. The method may be performed by the emotive assistant 100, or any other suitable emotive assistant. The emotive assistant may include a body structure, an actuation system configured to produce device motion, an image capture system, and a processing system operatively coupled to the image capture system and the actuation system.

At operation 1302, an event associated with information to be conveyed to the user is detected. The event may correspond to an alert (e.g., an application alert), a notification, an incoming message (e.g., email, text, etc.), a calendar or reminder item, an expiry of a timer, or the like. The event may be received from or associated with a remote device or system that is communicatively coupled to the emotive assistant.

At operation 1304, in response to detecting the event, the actuation system is caused to produce a selected device motion configured to capture the user’s attention. Causing the actuation system to produce the selected device motion may include causing the actuation system to move an articulatable member, causing a propulsion system to move the emotive assistant within its surroundings, or the like. The device motion may be selected from a set of candidate device motions, as described herein. As described herein, motion parameters for the selected device motion may be determined based on various contextual and/or environmental factors, including, without limitation, a relative importance or urgency of the event, characteristics of the environment (e.g., sound levels, light levels, number of people or objects in the environment, etc.), characteristics of the target user (e.g., the user’s motion, pose, gaze, posture, movements, voice activity, etc.), and the like.

At operation 1306, an image of the user may be captured with an image capture system. The image may be a video image or a still image.

At operation 1308, the image of the user is analyzed to determine an attention state of the user. In some cases, analyzing the image of the user to determine the attention state of the user comprises determining whether a gaze of the user is aimed at the emotive assistant. In some cases, analyzing the image of the user may include providing the image of the user as input to an attention identification model, the attention identification model trained on a set of images annotated with respective attention state information of respective subjects, and receiving, as output from the attention identification model, an indication of the attention state of the user. The attention identification model may be a machine learning model or may employ machine learning techniques.

At operation 1310, in accordance with a determination that the attention state of the user is indicative of attention being directed to the emotive assistant, the actuation system may cease producing the selected device motion. Thus, the device motion may continue (e.g., continuously, periodically, cyclically, or the like) until the emotive assistant determines that the user has directed their attention to the emotive assistant. In some cases, the emotive assistant may also cease the motion after a time period has expired, in response to a different user interaction, or after some other condition is satisfied.

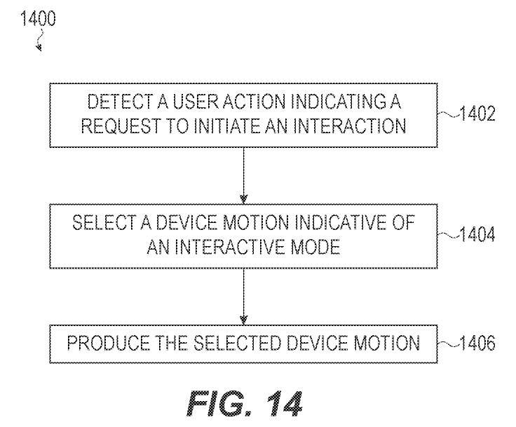

FIG. 14 is a flowchart depicting an example method 1400 by which an emotive assistant may respond to a user input with device motion that alerts the user to the state of the emotive assistant. The method may be performed by the emotive assistant 100, or any other suitable emotive assistant. The emotive assistant may include a body structure, an actuation system configured to produce device motion, an input system (e.g., for capturing images and/or audio inputs), and a processing system.

At operation 1402, a user action is detected. The user action may correspond to a request to initiate an interaction with the emotive assistant. In some cases, the request may correspond to an audio output from the user, such as a voice command. In some cases, the request may correspond to an attention cue from the user. The attention cue may be, for example, a motion of the user indicative of the user’s attention being directed to the emotive assistant, or a determination that a gaze of the user is aimed at the emotive assistant.

In some cases, detecting an attention cue by the user includes capturing an image of the user (e.g., with the input system), and analyzing the image of the user to detect the occurrence of the attention cue by the user. The analyzing may include providing the image of the user as input to an attention cue identification model, the attention cue identification model trained on a set of images annotated with respective attention cue information of respective subjects, and receiving, as output from the attention cue identification model, an indication of the occurrence of the attention cue by the user. As described herein, the attention cue may correspond to a movement of the user, a gaze direction of the user, a facial expression of the user, audio outputs from the user, and/or combinations of these (or other) factors.

At operation 1404, in response to detecting the user action corresponding to a request to initiate an interaction (e.g., an attention cue, a voice command, etc.), a device motion configured to indicate that the emotive assistant has received the request and that the emotive assistant has entered an interactive mode may be selected. The device motion may be selected from a set of candidate device motions. As described herein, motion parameters for the selected device motion may be determined based on various contextual and/or environmental factors, including, without limitation, a relative importance or urgency of the event, characteristics of the environment (e.g., sound levels, light levels, number of people or objects in the environment, etc.), characteristics of the target user (e.g., the user’s motion, pose, gaze, posture, movements, voice activity, etc.), and the like.

At operation 1406, (e.g., after the device motion is selected) an actuation system is caused to produce the selected device motion. For example, the actuation system may move an articulatable member to produce a selected device motion, or the actuation system may propel the device within its surroundings to produce the selected device motion. In some cases, the device motion may be representative of a facial feature, such as an eye, eyebrow, mouth, or the like.

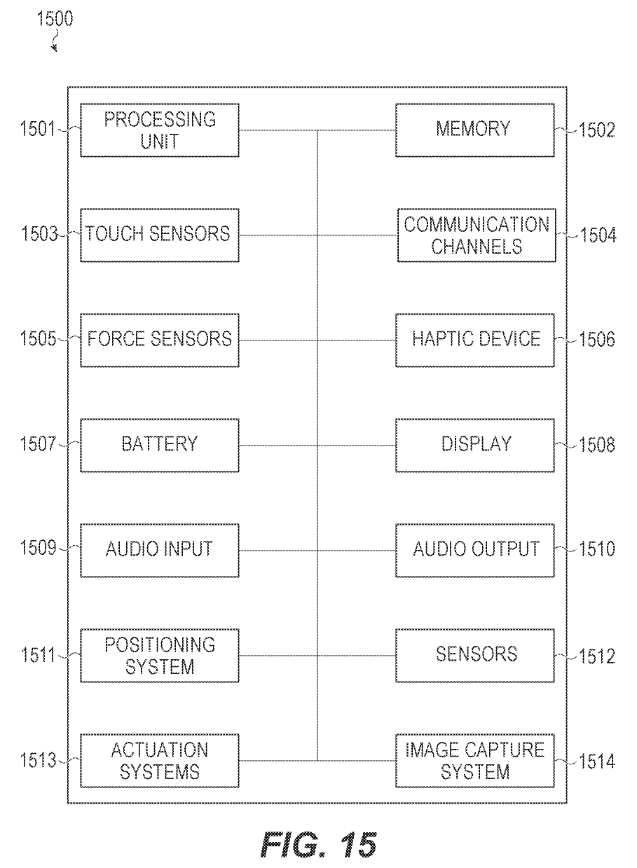

FIG. 15 depicts an example schematic diagram of an electronic device 1500. The electronic device 1500 may be an embodiment of or otherwise represent the emotive assistant 100, or any other emotive assistant, including any emotive assistant described herein. The device 1500 includes one or more processing units 1501 that are configured to access a memory 1502 having instructions stored thereon. The instructions or computer programs may be configured to perform one or more of the operations or functions described with respect to the electronic devices described herein. For example, the instructions may be configured to control or coordinate the operation of one or more actuation systems 1513 (e.g., for producing device motion), one or more displays 1508, one or more touch sensors 1503, one or more force sensors 1505, one or more image capture systems 1514, one or more communication channels 1504, one or more audio input systems 1509, one or more audio output systems 1510, one or more positioning systems 1511, one or more sensors 1512, and/or one or more haptic feedback devices 1506.

The processing units 1501 of FIG. 15 may be implemented as any electronic component capable of processing, receiving, or transmitting data or instructions. For example, the processing units 1501 may include one or more of: a microprocessor; a central processing unit (CPU); an application-specific integrated circuit (ASIC); a digital signal processor (DSP); or combinations of such devices. As described herein, the term “processor” is meant to encompass a single processor or processing unit, multiple processors, multiple processing units, or other suitably configured computing element or elements. The processing units 1501 may be coupled to a circuit board.

The memory 1502 can store electronic data that can be used by the device 1500. For example, a memory can store electronic data or content such as, for example, audio and video files, images, documents and applications, device settings and user preferences, programs, instructions, timing and control signals or data for the various modules, data structures or databases, and so on. The memory 1502 can be configured as any type of memory. By way of example only, the memory can be implemented as random access memory, read-only memory, Flash memory, removable memory, or other types of storage elements, or combinations of such devices. The memory 1502 may be coupled to a circuit board.

The touch sensors 1503 may detect various types of touch-based inputs and generate signals or data that are able to be accessed using processor instructions. The touch sensors 1503 may use any suitable components and may rely on any suitable phenomena to detect physical inputs (e.g., touch inputs, haptic inputs). For example, the touch sensors 1503 may be capacitive touch sensors, resistive touch sensors, acoustic wave sensors, or the like. The touch sensors 1503 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 1503 may be integrated with or otherwise configured to detect touch inputs applied to any portion of the device 1500. For example, the touch sensors 1503 may be configured to detect touch inputs applied to any portion of the device 1500, including a device housing and/or exterior surfaces, a display, etc. A touch sensor may also or instead be integrated with a display. The touch sensors 1503 may operate in conjunction with the force sensors 1505 to generate signals or data in response to touch inputs. A touch sensor or force sensor that is positioned over a display surface or otherwise integrated with a display may be referred to herein as a touch-sensitive display, force-sensitive display, touchscreen display, or touchscreen.

The force sensors 1505 may detect various types of force-based inputs and generate signals or data that are able to be accessed using processor instructions. The force sensors 1505 may use any suitable components and may rely on any suitable phenomena to detect physical inputs. For example, the force sensors 1505 may be strain-based sensors, piezoelectric-based sensors, piezoresistive-based sensors, capacitive sensors, resistive sensors, or the like. The force sensors 1505 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 1505 may be used in conjunction with various input mechanisms to detect various types of inputs. For example, the force sensors 1505 may be used to detect presses or other force inputs that satisfy a force threshold (which may represent a more forceful input than is typical for a standard “touch” input). Like the touch sensors 1503, the force sensors 1505 may be integrated with or otherwise configured to detect force inputs applied to any portion of the device 1500. For example, the force sensors 1505 may be configured to detect force inputs applied to any portion of the device 1500 that includes a display (and may be integrated with a display). The force sensors 1505 may operate in conjunction with the touch sensors 1503 to generate signals or data in response to touch- and/or force-based inputs.

The device 1500 may also include one or more haptic devices 1506. The haptic device 1506 may include one or more of a variety of haptic technologies such as, but not necessarily limited to, rotational haptic devices, linear actuators, piezoelectric devices, vibration elements, and so on. In general, the haptic device 1506 may be configured to provide punctuated and distinct feedback to a user of the device. More particularly, the haptic device 1506 may be adapted to produce a knock or tap sensation and/or a vibration sensation. Such haptic outputs may be provided in response to detection of touch and/or force inputs, and may be imparted to a user through the exterior surface of the device 1500 (e.g., via a glass or other surface that acts as a touch- and/or force-sensitive display or surface).

The one or more communication channels 1504 may include one or more wireless interface(s) that are adapted to provide communication between the processing unit(s) 1501 and an external device. The one or more communication channels 1504 may include antennas (e.g., antennas that include or use housing components as radiating members), communications circuitry, firmware, software, or any other components or systems that facilitate wireless communications with other devices. In general, the one or more communication channels 1504 may be configured to transmit and receive data and/or signals that may be interpreted by instructions executed on the processing units 1501. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces (e.g., for communicating using Wi-Fi communication standards and/or protocols, including IEEE 802.11, 802.11b, 802.11a, 802.11g, 802.11n, 802.11ac, 802.11ax (Wi-Fi 6, 6E), 802.11be (Wi-Fi 7), or any other suitable Wi-Fi standards and/or protocols), TCP/IP interfaces, network communications interfaces, or any conventional communication interfaces. The one or more communications channels 1504 may also include ultra-wideband (UWB) interfaces, which may include any appropriate communications circuitry, instructions, and number and position of suitable UWB antennas.

As shown in FIG. 15, the device 1500 may include a battery 1507 that is used to store and provide power to the other components of the device 1500. The battery 1507 may be a rechargeable power supply that is configured to provide power to the device 1500. The battery 1507 may be coupled to charging systems (e.g., wired and/or wireless charging systems) and/or other circuitry to control the electrical power provided to the battery 1507 and to control the electrical power provided from the battery 1507 to the device 1500.

The device 1500 may also include one or more displays 1508 configured to display graphical outputs. The displays 1508 may use any suitable display technology, including liquid crystal displays (LCD), organic light-emitting diodes (OLED), active-matrix organic light-emitting-diode displays (AMOLED), or the like. The displays may use a low temperature polycrystalline silicone (LTPS) or low temperature polycrystalline oxide (LTPO) backplane. The displays 1508 may display graphical user interfaces, images, icons, or any other suitable graphical outputs. As described herein, the displays 1508 may convey information about the attention state of an emotive assistant, and/or may produce outputs that are configured to direct a user’s attention towards an event, object, or direction.

The device 1500 may also provide audio input functionality via one or more audio input systems 1509. The audio input systems 1509 may include microphones, transducers, or other devices that capture sound for voice calls, video calls, audio recordings, video recordings, voice commands, and the like.

The device 1500 may also provide audio output functionality via one or more audio output systems (e.g., speakers) 1510, such as the speaker systems and/or modules described herein. The audio output systems 1510 may produce sound from voice calls, video calls, streaming or local audio content, streaming or local video content, or the like.

The device 1500 may also include a positioning system 1511. The positioning system 1511 may be configured to determine the location of the device 1500. For example, the positioning system 1511 may include magnetometers, gyroscopes, accelerometers, optical sensors, cameras, global positioning system (GPS) receivers, inertial positioning systems, or the like. The positioning system 1511 may be used to determine spatial parameters of the device 1500, such as the location of the device 1500 (e.g., geographical coordinates of the device), measurements or estimates of physical movement of the device 1500, an orientation of the device 1500, or the like. The positioning system 1511 may determine the location and/or position of the electronic device relative to a user. Thus, information from the positioning system 1511 may be analyzed in conjunction with information from an image capture system 1514, which may be used to determine the location of a user (or other object, individual, event, etc.) relative to the device 1500.

The device 1500 may also include one or more additional sensors 1512 (also referred to as sensing systems) to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensing systems (e.g., fingerprint sensors, facial recognition systems, photoplethysmographs, blood-oxygen sensors, blood sugar sensors, or the like), eye-tracking sensors, proximity sensors, depth sensors (e.g., time-of-flight based depth or distance sensors), ambient light sensors, retinal scanners, humidity sensors, buttons, switches, lid-closure sensors, or the like.

The device 1500 may also include one or more image capture systems 1514. The image capture system 1514, along with the audio input system 1509 and optionally other systems, may be part of an overall input system of the device 1500. The image capture system 1514 may include one or more cameras, and may be configured to capture images (e.g., still and/or video images). Captured images may be stored as displayable image files, and/or used as inputs to the device 1500 for other operations. For example, captured images may be analyzed to determine attention cues from a user, determine an attention state of the user (e.g., whether a user has directed their attention towards an emotive assistant), or the like. The image capture system 1514 may also be used to determine a location of a user (e.g., an absolute location, a location relative to the electronic device or to other features in the user’s surroundings). The image capture system 1514 may include an imaging sensor, an image processor, a lens, and other components to facilitate the image capture operations of the image capture system 1514.

The device 1500 may also include one or more actuation systems 1513. The actuation systems 1513 may be configured to produce device motion, including motion of articulatable members (e.g., articulation, rotation, or other movement of arms, heads, facial features, housing components, movable windows or covers, etc.), or overall propulsion motion of the device (e.g., translation, rotation, flight, etc.). The actuation systems 1513 may include motors, actuators, gear systems, linkages, and/or any other mechanisms, controllers, or systems to produce device motion. The actuation systems 1513 may be operatively coupled to the processing units 1501, which may control the operations of the actuation systems 1513 to produce device motions, as described herein.

To the extent that multiple functionalities, operations, and structures described with reference to FIG. 15 are disclosed as being part of, incorporated into, or performed by the device 1500, it should be understood that various embodiments may omit any or all such described functionalities, operations, and structures. Thus, different embodiments of the device 1500 may have some, none, or all of the various capabilities, apparatuses, physical features, modes, and operating parameters discussed herein. Further, the systems included in the device 1500 are not exclusive, and the device 1500 may include alternative or additional systems, components, modules, programs, instructions, or the like, that may be necessary or useful to perform the functions described herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device configured to capture a user’s attention with motion outputs, the electronic device comprising:
a body structure;
an actuation system configured to produce device motion;
an image capture system; and
a processing system operatively coupled to the image capture system and the actuation system and configured to:
detect an event associated with information to be conveyed to a user;
in response to detecting the event, cause the actuation system to produce a selected device motion configured to capture the user’s attention;
capture an image of the user with the image capture system;
analyze the image of the user to determine an attention state of the user; and
in accordance with a determination that the attention state of the user is indicative of attention being directed to the electronic device, cause the actuation system to cease producing the selected device motion.

2. The electronic device of claim 1, wherein:
the electronic device further comprises an articulatable member;
the actuation system is configured to move the articulatable member; and
causing the actuation system to produce the selected device motion includes causing the actuation system to move the articulatable member.

3. The electronic device of claim 1, wherein:
the actuation system comprises a propulsion system; and
causing the actuation system to produce the selected device motion includes causing the propulsion system to move the electronic device within its surroundings.

4. The electronic device of claim 1, wherein the processing system is further configured to, prior to causing the actuation system to produce the selected device motion, select the device motion from a set of candidate device motions.

5. The electronic device of claim 1, wherein analyzing the image of the user to determine the attention state of the user comprises:
providing the image of the user as input to an attention identification model, the attention identification model trained on a set of images annotated with respective attention state information of respective subjects; and
receiving, as output from the attention identification model, an indication of the attention state of the user.

6. The electronic device of claim 1, wherein the processing system is further configured to, in accordance with a determination that the attention state of the user is not indicative of attention being directed to the electronic device, cause the actuation system to produce an alternative device motion.

7. The electronic device of claim 1, wherein analyzing the image of the user to determine the attention state of the user comprises determining whether a gaze of the user is aimed at the electronic device.

8. An electronic device configured to indicate a device state to a user via motion outputs, the electronic device comprising:
a body structure;
an actuation system configured to produce device motion;
an input system comprising:
an image capture system; and
an audio input system; and
a processing system operatively coupled to the input system and the actuation system and configured to:
detect, from a user and with the input system, a request to initiate an interaction with the electronic device; and
in response to detecting the request:
select a device motion configured to indicate that the electronic device has received the request and that the electronic device has entered an interactive mode; and
cause the actuation system to produce the selected device motion.

9. The electronic device of claim 8, wherein:
the electronic device further includes a display configured to produce graphical outputs; and
determining the device motion comprises:
determining a location of the user relative to the electronic device; and
determining a motion that will cause the display to be oriented towards the user.

10. The electronic device of claim 8, wherein:
the electronic device further comprises a movable structure representative of a facial feature; and
determining the device motion comprises determining a motion of the movable structure that is indicative of attention being directed to the user.

11. The electronic device of claim 10, wherein the movable structure is representative of an eye.

12. The electronic device of claim 8, wherein detecting the request to initiate the interaction with the electronic device comprises detecting, with the audio input system, an audio output from the user.

13. The electronic device of claim 8, wherein detecting the request to initiate the interaction with the electronic device comprises detecting, with the image capture system, a motion of the user indicative of the user’s attention being directed to the electronic device.

14. The electronic device of claim 8, wherein detecting the request to initiate the interaction with the electronic device comprises determining, with the image capture system, that a gaze of the user is aimed at the electronic device.

15. An electronic device configured to initiate an interactive mode in response to an attention cue from a user, the electronic device comprising:
a body structure;
an actuation system configured to produce device motion;
an image capture system configured to capture an image of a user; and
a processing system operatively coupled to the image capture system and the actuation system and configured to:
detect, based on an analysis of the image of the user, an occurrence of an attention cue by the user;
in response to detecting the occurrence of the attention cue, select a device motion configured to indicate that the electronic device has detected the attention cue and that the electronic device has entered an interactive mode; and
cause the actuation system to produce the selected device motion.

16. The electronic device of claim 15, wherein the processing system is further configured to analyze the image of the user to detect the occurrence of the attention cue by the user, the analyzing comprising:
providing the image of the user as input to an attention cue identification model, the attention cue identification model trained on a set of images annotated with respective attention cue information of respective subjects; and
receiving, as output from the attention cue identification model, an indication of the occurrence of the attention cue by the user.

17. The electronic device of claim 15, wherein:
the electronic device further comprises a movable structure representative of a facial feature; and
determining the device motion comprises determining a motion of the movable structure that is indicative of attention being directed to the user.

18. The electronic device of claim 15, wherein:
the actuation system comprises a propulsion system configured to move the electronic device within its surroundings;
determining the device motion comprises determining a motion of the electronic device that orients a front of the electronic device towards the user; and
causing the actuation system to produce the selected device motion comprises causing the propulsion system to move the electronic device to orient the front of the electronic device towards the user.

19. The electronic device of claim 18, wherein determining the device motion further comprises determining a location of the user relative to the front of the electronic device.

20. The electronic device of claim 15, wherein:
the electronic device further comprises an articulatable member;
the actuation system is configured to move the articulatable member;
determining the device motion comprises selecting a motion of the articulatable member from a set of candidate motions; and
causing the actuation system to produce the selected device motion includes causing the actuation system to move the articulatable member in accordance with the selected motion.
